(19) United States
(12) Patent Application Publication
(10) Pub. No.: US 2014/0138353 A1
(43) Pub. Date: May 22, 2014

(54) PROCESS FOR PERFORMING METAL LIFT-OFF

(71) Applicant: DYNALOY, LLC, Kingsport, TN (US)

(72) Inventors: Richard Dalton Peters, Kingsport, TN (US); Keith Allen Cox, Kingsport, TN (US)

(73) Assignee: DYNALOY, LLC, Kingsport, TN (US)

(21) Appl. No.: 13/682,981

(22) Filed: Nov. 21, 2012

(51) Int. Cl. B08B 3/02

(52) U.S. Cl. CPC B08B 3/02
USPC 216/41; 134/34; 134/37

(57) ABSTRACT

A process is described to perform lift-off of a metal layer. A spray is applied to a patterned surface coated with the metal layer. An incidence angle and pressure of the spray are sufficient to separate the metal layer from a substance coated with the metal without separating the substance from an underlying substrate.

### STATEMENT OF JOINT DEVELOPMENT

This invention was created pursuant to a joint development agreement between Eastman Chemical Co. and EV Group. The aforementioned joint development agreement was in effect on or before the date the claimed invention was made, and the claimed invention was made as a result of activities undertaken within the scope of the joint development agreement.

### BACKGROUND

Lift-off processes are used extensively in the microelectronics industry in the fabrication of different types of devices including radio frequency (RF) devices, microelectromechanical (MEM) devices, and light emitting diodes (LED). In a lift-off process, a photoresist layer may be patterned to produce holes in the photoresist layer where an underlying substrate is exposed. A metal film is then blanket deposited covering the remaining patterned photoresist and deposited into the holes in the photoresist where the metal film covers the substrate. Techniques for blanket deposition of metal films include vapor deposition, sputtering, and evaporation. The photoresist film may then be removed by immersion in a bath containing an organic solvent. The organic solvent may be heated to an elevated temperature that is below its flashpoint. As the photoresist is dissolved by the organic solvent and removed from the substrate, the metal film attached to the photoresist is also removed or lifted-off. The metal film that is deposited onto the substrate through the holes in the patterned photoresist remains attached to substrate because the organic solvent has little or no effect on the metal film and the substrate. These types of processes typically require either baths that use large volumes of organic solvent and/or long times to completely remove the photoresist from the substrate.

An alternative process to performing metal film lift-off is to use a pressure-sensitive adhesive tape that is applied to the entire surface of a wafer where the metal film has been deposited on top of a patterned photoresist. The tape adheres to the metal film that is deposited on top of the photoresist. The tape is removed, and metal on top of photoresist is removed along with the tape. After the tape and metal film removal step, the photoresist remains on the substrate so the photoresist is then removed using an organic solvent. However, with this process, adhesive residue from the tape may remain on top of metal features on the substrate. The adhesive residue may be difficult to remove. Additionally, this is a two-step process that requires different equipment to complete the metal removal and photoresist removal steps.

A technique that can perform metal lift-off using reduced volumes of organic solvent and/or with shorter processing times would be advantageous with regards to reducing negative environmental impact and processing costs.

### SUMMARY

This summary is provided to introduce simplified concepts of techniques for removing metal layers from substances such as, for example, radio frequency (RF) devices, microelectromechanical (MEM) devices, and light emitting diodes (LED). Additional details of example techniques are further described below in the Detailed Description. This summary is not intended to identify essential features of the claimed subject matter, nor is it intended for use in determining the scope of the claimed subject matter.

In one implementation, a fluid spray is applied to a substance at an incidence angle and pressure sufficient to separate a metal layer on the substance from the substance without removing the substance from a substrate on which the substance is disposed. The substance and the substrate are dried and the substance is removed. The spraying, drying, and removing may all occur while the substance and the substrate remain in the same bowl.

In another implementation, a liquid is applied to a surface of the substance for a period of time and at a temperature sufficient to enhance removal of at least a portion of a metal layer from the substance by spraying with a fluid. The substance is sprayed with the fluid at a pressure and an incidence angle sufficient to remove the metal layer from the substrate without removing a significant amount of the substance from the substrate. The substance and the substrate are dried and the substance is removed from the substrate. Applying the liquid, the spraying, the drying, and the removing may all occur while the substance and the substrate remain in the same bowl.

### BRIEF DESCRIPTION OF THE DRAWINGS

FIGS. 1A and 1B show an illustrative top view and an illustrative side view of a spray nozzle positioned above a center of a circular wafer.

FIGS. 2A and 2B show an illustrative top view and an illustrative side view of a spray nozzle moving relative to a circular wafer as the wafer rotates.

### DETAILED DESCRIPTION

There exists a need for improved techniques to remove metal films from surfaces of photoresists following deposition of a metal film on the surface of a patterned photoresist. The metal film may be comprised of atoms of a metal such as aluminum, copper, gold, titanium, indium, tungsten, chromium, nickel, tantalum, molybdenum, palladium, or platinum. The current invention uses the mechanical force of a spray of material to remove the metal from the underlying photoresist without removing the photoresist from the substrate or removing the metal from the substrate. The disclosed techniques for lift-off of metal films may be applied to a wafer or other material while in a bowl without need to remove the wafer from the bowl.

Once the metal film is removed from the surface of the photoresist, the photoresist may be removed from the substrate using any suitable stripping technique such as placing the photoresist patterned substrate in a bath of stripping solution. As an additional example, the photoresists may be removed by a single-wafer stripping process that coats the surface of a wafer with an organic solvent that disassociates the photoresist. One suitable single-waver stripping process is the CoatsClean® process that may be performed on the same wafer and in the same bowl in which the lift-off was performed.

The techniques described in this disclosure achieve lift-off of metal films from substances such as photoresists using a narrow angle, fluid spray onto the surface of a substance coated with a metal layer such as, but not limited to, a metal film. The substance may be an organic substance such as, but not limited to, a photoresist. The substrate under the substance may be an inorganic substrate such as a semiconductor. Any suitable substrate used for wafer manufacturing may be used. The spray may be a liquid or gaseous spray. In some implementations the spray may be water or an aqueous solution including aqueous solutions that contain more than about 95% water and also aqueous solutions that contain more than about 99% water. The gaseous spray may be an inert gas including, but not limited to, nitrogen.

The spray may be applied to the substance coated with the metal layer without prior treatment or after the metal layer and the substance are exposed to a liquid that aids the ability of the spray to separate the metal from the substance. The liquid may be a solvent such as a basic aqueous solution, an acid aqueous solution, a water-soluble organic solvent, or a non-polar solvent. Basic aqueous solutions that may be used include any solution that contains potassium hydroxide, sodium hydroxide, lithium hydroxide, ammonium hydroxide, tetramethylammonium hydroxide, tetraethylammonium hydroxide, tetrabutylammonium hydroxide, dimethyldipropylammonium hydroxide, dimethyldiethylammonium hydroxide, benzyltrimethylammonium hydroxide or mixtures of these bases with each other and/or with other substances. Water-soluble organic solvents that may be used include dimethyl sulfoxide (DMSO), n-methyl pyrrolidone (NMP), diethylene glycol monobutyl ether (DB solvent), diethylene glycol monoethyl ether (DE solvent), diethylene glycol monopropyl ether; diethyleneglycol monomethylether, diethylene glycol dimethyl ether, diethylene glycol diethyl ether, diethylene glycol dipropylether, diethylene glycol dibutylether, isopropanol, acetone, monoethanolamine (MEA), dimethylformamide, dimethylacetamide or mixtures of these solvents with each other and/or with other substances.

The liquid may be applied to the surface of a metal layer covering a substance for a period of time and at a temperature sufficient for chemical interaction between the liquid and the substance to cause at least a portion of the metal layer to separate from the substance. The liquid may be applied as a small volume localized to a particular location, e.g., the center, on the surface of the metal layer. A single drop of liquid with a volume of about 5 μL may be applied. Larger volumes of liquid such as from about 5 μL to about 50 μL, about 10 μL to about 40 μL, or about 20 μL to about 30 μL may also be applied to a portion of the surface of the metal layer. Applying a small volume of liquid may be suitable for some embodiments. In other embodiments, liquid may be applied to cover all or most of the surface of the metal layer. For example, a wafer coated with the metal layer may be immersed in a bath containing the liquid or the liquid may be applied on top of the wafer while the wafer is held in a bowl. The preferred embodiment may depend upon the photoresist pattern density, the amount of remaining photoresist, and the thickness of the metal film.

Suitable temperatures for applying the liquid, either as a small volume or as a larger volume, include room temperature as well as other temperatures. If the liquid is heated, the liquid may be preheated before application or the liquid may be heated after it is applied to the wafer, for example by bringing a heater into proximity with the liquid after the liquid is applied to the metal layer. In other embodiments, the liquid, or the substrate may be heated by other means including but not limited to conductive or radiative heating. The liquid may be allowed to sit and react with the substance for a period of time sufficient to cause separation between the metal layer and substance. This period of time may include between about 5 and 300 seconds including between about 15 and 60 seconds.

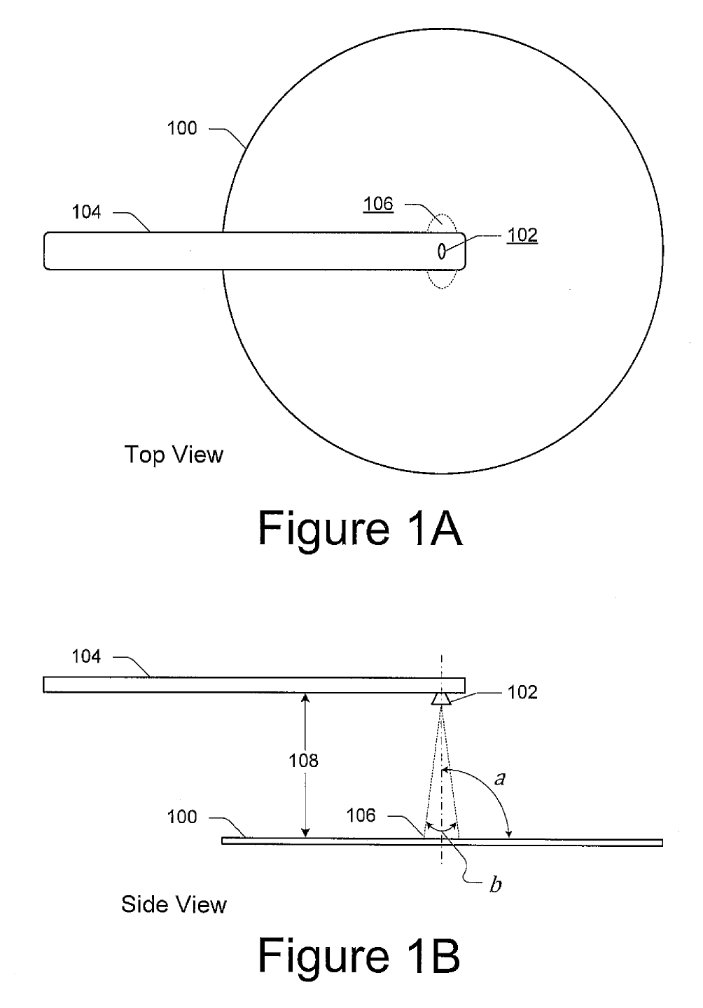

Techniques for applying the spray are discussed in conjunction with the accompanying figures. FIG. 1A shows a top view of a wafer 100 underneath a nozzle 102 supported by an arm 104. In this view, the nozzle 102 is positioned over the center of the wafer 100. An area contact 106 of spray from the nozzle 102 onto the surface of the wafer 100 is shown by a dotted oval. In some embodiments, nozzle 102 may spray water onto the surface of the wafer 100 with a feed pressure of between about 25 and 200 pounds square inch gauge (psig), with a feed pressure between about 30 and 100 psig, or with a feed pressure between about 35 and 55 psig.

FIG. 1B shows a side view of the arrangement illustrated in FIG. 1A. The angle a is the angle of incidence between the spray and the wafer 100. An angle a of 90° corresponds with the spray being directed straight down onto the surface of the wafer 100. The nozzle 102 may or may not be oriented at the same angle as the angle of incidence of the spray. The angle a is defined by the angle between the stream formed from the spray and the wafer 100 (or other substance contacted by the spray) rather than by an orientation of the nozzle 102. In some embodiments the angle a may be less than 90° such as an angle greater than about 85° or even an angle greater than about 45°. The nozzle 102 may be a fan nozzle with a nozzle spray angle of between about 5° and 45°, between about 10° and 20°, or about 15°. The nozzle spray angle is represented by angle b.

The nozzle 102 may be separated from the wafer 100 by a separation distance 108. The separation distance 108 may be between about 1 cm and about 10 cm including a distance of about 4 cm. In order to achieve sufficient mechanical force to lift off the metal layer without removing the underlying substance or damaging features on the wafer 100, the feed pressure and the separation distance 108 may be altered separately or together. Depending, for example, on limitations of available equipment the feed pressure may be increased to compensate for a greater separation distance 108, the separation distance 108 may be decreased to compensate for lower feed pressure, or other modifications may be made to either or both of the separation distance 108 and the feed pressure. Specific combinations of feed pressures and separation distances for particular operating conditions may be identified by one of ordinary skill in the art through applying these techniques to multiple test samples and observing the results with unaided vision and/or with optical microscopy.

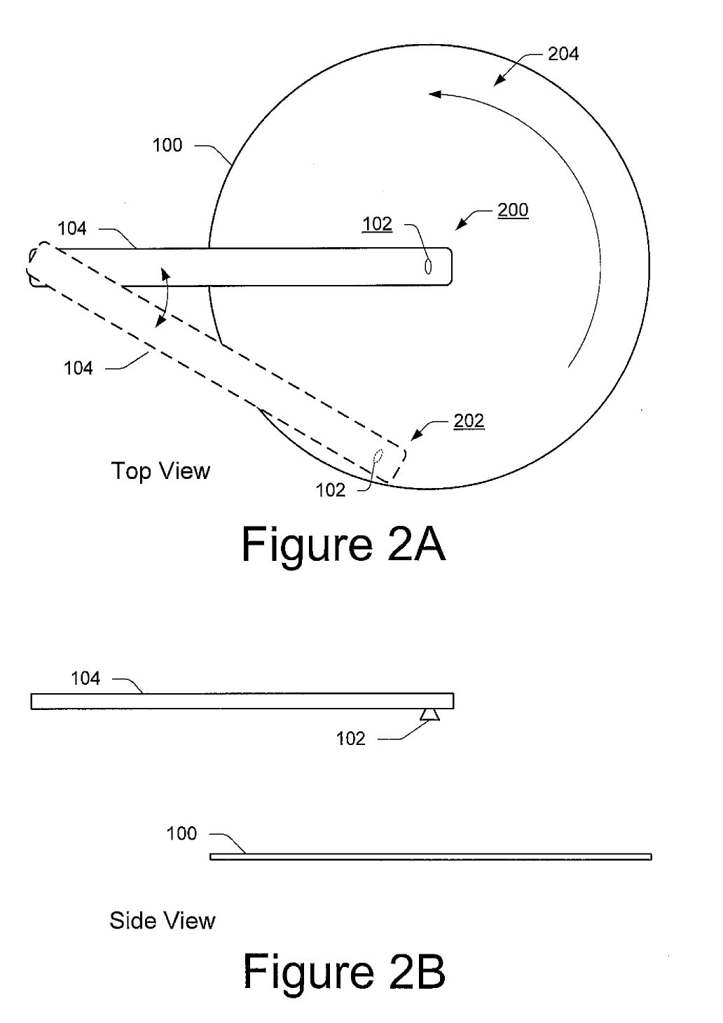

FIG. 2A shows movement of the arm 104 between a first position 200 at the center of the wafer 100 and a second position 202 at the edge of the wafer 100. The arm 104 may start at the first position 200 wherein the nozzle 102 is located over the center of the wafer 100. Application of the spray from the nozzle 102 may cause lift-off of the metal layer at the center of the wafer 100. The spray may be applied to the center of the wafer 100 for period of time between about 3 seconds and 90 seconds. In embodiments in which a liquid is not applied to the surface of the wafer 100 prior to the spray, the period of time may be between about 30 seconds and 90 seconds including a period of time of about 60 seconds. In embodiments in which the liquid is applied to the surface of the wafer 100 prior to the spray, the period of time for this initial spray may be between about 1 seconds and 30 seconds or between about 5 seconds and 10 seconds. In some embodiments, when the liquid is applied at a discreet location on the surface of the wafer 100 the initial spray is applied at that same location. For example, after a drop of liquid is applied to the center of the wafer 100, the initial spray may also be applied at the center of the wafer 100 as illustrated here by the first position 200. However, the location of the initial spray and the discrete location on the surface of the wafer 100 to which the liquid is applied is not limited to the center of the wafer 100.

The wafer 100 may be rotated as illustrated by arrow 204. Counterclockwise rotation is illustrated in FIG. 2A; however, clockwise rotation as well as rotation alternating between counterclockwise and clockwise directions is also possible. During the initial spray, for example while the arm 104 is at position 200, the wafer 100 may be rotated at a rate about 500 rpm or slower including a rate of about 250 rpm or slower, a rate of about 100 rpm or slower, and also including a rate of about 60 rpm. After the initial spray, whether at the center of the wafer 100 or at another location, the arm 104 may be moved to the second position 202 near the edge of the wafer 100. The second position 202 may also be off the wafer, beyond the edge of the wafer. The spray may be continued while the arm 104 is moved. Rotation of the wafer 100 may continue while the arm 104 is moved between the first position 200 and the second position 202 thereby causing the spray to contact the entire surface of the wafer 100. The arm 104 may return from the second position 202 to the first position 200 and movement of the arm 104 between these two positions may be repeated multiple times. Movement of the arm 104 between the first position 200 and the second position 202 may be caused by rotation of the arm 104 as illustrated in FIG. 2A. Alternatively, the arm 104 may be moved in a linear motion between the first position 200 and the second position 202 by extension and retraction of the arm 104. Other techniques and/or movement paths for the arm 104 between the center and edge of the wafer or other surface are equally suitable. In some embodiments, the arm 104 may be briefly paused, e.g., for about 2 to 5 seconds, at the edge of the wafer 100 before returning to the first position 200.

FIG. 2B shows a side view of the arrangement illustrated in FIG. 2A.

After spraying has removed the metal layer from the top of the photoresist or other substance, the substrate, e.g., wafer, may be dried. According to an embodiment, the substrate and remaining substance can be dried by, for example spin drying, blow drying, or heating. Isopropanol may be applied prior, during, or after spin drying to facilitate complete drying. Instead of isopropanol, other liquids may be used that act as drying aids such as acetone, or alternatively, vapor saturated with isopropanol or a similar solvent can be applied to aid drying.

Following drying, the remaining substance, e.g., photoresist or other organic layer, may be removed from the substrate using any conventional technique such as immersion in a solvent bath, or application of a solvent to the substance and the substrate while both remain in the same bowl that was used for the lift-off techniques described above. One technique for removing substances such as photoresists without moving a wafer from the bowl in which it was previously processed is the CoatsClean® process.

### EXAMPLES

The techniques described above are further illustrated by, but not limited to, the following examples wherein all percentages given are by weight unless specified otherwise.

The starting material for each of the examples discussed below is a 150 mm compound semiconductor wafer with patterned photoresist, where an image reversal photoresist was used that resulted in an inverted profile such that the photoresist features are undercut, i.e., the width of the patterned photoresist features was greater at the top of the feature than at the bottom of the feature next to the wafer substrate underlying the photoresist. After photoresist patterning, a film of metal was deposited onto the wafer. In areas of the wafer in which the photoresist was removed by the patterning, the metal film was deposited directly onto the wafer substrate and adhered to the wafer. In areas of the wafer where the photoresist features remained, the metal film was deposited onto the top of the photoresist and adhered to the photoresist. The inverted profile of the photoresist features prevented deposition of the metal film onto the sidewalls of the photoresist features, and created a discontinuous film of metal across the entire wafer surface. Thus, metal that was deposited on top of photoresist is not connected to metal that was deposited onto the wafer substrate due to the undercut of the photoresist features. Wafers prepared in this manner were subjected to the techniques described below.

### Example 1

The wafer was processed using an EVG 301RS single wafer photoresist stripping equipment for all subsequent steps. The wafer was subjected to a stationary, high-velocity spray of water with a 15° angle of spread near the center of the wafer at an incident angle of 90°, a nozzle-wafer separation distance of 4 cm, and a feed pressure of 40 psig for 60 seconds. The wafer was rotating during the water spraying process at 1000 rpm. After the 60 seconds of spraying, removal of the metal lift-off layer from the center area of the wafer was observed. The metal lift-off layer was not removed from areas of the wafer other than the center. The spray of water operating at the same feed pressure as before, was then swept across the wafer at a constant incident angle of 90° starting at the center of the wafer and moving towards the edge of the wafer for 15 seconds while the wafer was rotating at 1000 rpm. During this sweeping spray, the remaining metal lift-off film was removed from the wafer. Optical microscopy of the wafer at this point confirmed complete removal of the metal lift-off film from the surface of the photoresist. However, the underlying photoresist was still present on the wafer.

The photoresist was then removed by coating the top of the wafer with 10 mL of a stripping solution of 38 wt % dimethylsulfoxide (DMSO), 35.2 wt % monoethanolamine (MEA), 22.8 wt % diethylene glycol monobutyl ether (DB solvent), and 4 wt % diethylene glycol (DEG). The liquid-coated wafer was heated for 45 seconds to a temperature of ˜115° C., and then the wafer was rinsed with deionized water to wash away the stripping solution and the photoresist. Metal film remained on portions of the wafer that were exposed by the patterning of the photoresist.

### Example 2

The following processing was all performed on EVG 301RS single wafer photoresist stripping equipment. A single drop (˜5 μL) of a 0.5N aqueous solution of KOH was deposited onto the center of one of the wafers described above. The solution was allowed to sit on the wafer at room temperature for 15 seconds. After 15 seconds, the wafer was subjected to a stationary, high-velocity spray of water at the center of the wafer on the same spot where the KOH solution was applied. The water spray was delivered using a fan nozzle with a 15° spray angle at an incident angle of 90°, a nozzle-wafer separation distance of 4 cm, and a feed pressure of 45 psig for 5 seconds. The wafer was rotating during the water spraying process at 60 rpm. After 5 seconds, the metal lift-off layer had been removed from the center area of the wafer that was sprayed with water, but the metal lift-off layer was not removed from outer areas of the wafer. The high-velocity spray of water was then swept across the wafer at a constant incident angle of 90° starting at the center of the wafer and moving towards the edge of the wafer for 15 seconds then back to the center of the wafer for 15 seconds while the wafer was rotating at 60 rpm. During this sweeping spray, the remaining metal lift-off film was removed from the wafer, and visual inspection showed that all of the metal lift-off film was removed during the initial center-to-edge 15 second sweep, i.e., the metal lift-off film was removed before the 15 second sweep back to the center of the wafer. Optical microscopy of the wafer following both the center-to-edge sweep and edge-to-center sweep confirmed complete removal of the metal lift-off film without removing the underlying photoresist.

The photoresist was then removed by coating the top of the wafer with 12 mL of a stripping solution of 38 wt % dimethylsulfoxide (DMSO), 35.2 wt % monoethanolamine (MEA), 22.8 wt % diethylene glycol monobutyl ether (DB solvent), and 4 wt % diethylene glycol (DEG). The liquid-coated wafer was heated for 60 seconds to a temperature of ˜125° C. After heating, the wafer was spun at 2500 rpm while dispensing a stream of the fresh stripping solution to the center of the wafer for 3 seconds. After this solution rinse, the wafer was rinsed with deionized water for 14 seconds, and finally spun dry at 2500 rpm for 20 seconds. Metal film remained on portions of the wafer that were exposed by the patterning of the photoresist.

### Example 3

This example concerns a wafer with a darkfield pattern in which the area of photoresist removed after photolithography development was less than the area of photoresist remaining after development. Thus, the metal lift-off film on top of the photoresist covered more than 50% of the total wafer surface.

The following processing was all performed on EVG 301RS single wafer photoresist stripping equipment. The entire top surface of the wafer was coated with dimethylsulfoxide (DMSO) and allowed to sit on the wafer at room temperature for 60 seconds. After 60 seconds, the wafer was subjected to a stationary, high-velocity spray of water at the center of the wafer. The water spray was delivered using a fan nozzle with a 15° spray angle at an incident angle of 90°, a nozzle-wafer separation distance of −4 cm, and a feed pressure of 45 psig for 6 seconds. The wafer was rotating during the water spraying process at 200 rpm. After 6 seconds, the metal lift-off layer had been removed from the center area of the wafer that had been sprayed with water, but the metal lift-off layer was not removed from outer areas of the wafer. The high-velocity spray of water was then swept across the wafer at a constant incident angle of 90° starting at the center of the wafer and moving towards the edge of the wafer for 15 seconds while the wafer was rotating at 60 rpm, and finally, the spray was held at the wafer edge for an additional 3 seconds. During this sweeping spray, the remaining metal lift-off film was removed from the wafer. Optical microscopy of the wafer at this point confirmed complete removal of the metal lift-off film without removing the underlying photoresist.

The photoresist was then removed by coating the top of the wafer with 12 mL of a stripping solution of 38 wt % dimethylsulfoxide (DMSO), 35.2 wt % monoethanolamine (MEA), 22.8 wt % diethylene glycol monobutyl ether (DB solvent), and 4 wt % diethylene glycol (DEG). The liquid-coated wafer was heated for 30 seconds to a temperature of ˜90° C. After heating, the wafer was spun at 2500 rpm while dispensing a stream of the fresh stripping solution to the center of the wafer for 3 seconds. After this solution rinse, the wafer was rinsed with deionized water for 20 seconds, and finally spun dry at 3000 rpm for 20 seconds. Metal film remained on portions of the wafer that were exposed by the patterning of the photoresist.

Although implementations have been described in language specific to methodological acts, the implementations are not necessarily limited to the specific acts described. Rather, the specific acts are disclosed as illustrative forms of implementing the claims.

What is claimed is:

1. A method for removing a metal layer that contacts a substance, said substance disposed on a substrate, the method comprising:
applying a fluid spray to the metal layer at an incidence angle and pressure sufficient to separate at least a portion of the metal layer from the substance without completely removing the substance from the substrate; and
removing the substance from the substrate, wherein the removing occurs in a same bowl as the applying and the drying.

2. The method of claim 1, wherein the metal layer comprises metal applied to a surface of the substrate by vapor deposition, sputtering, or evaporation.

3. The method of claim 1, wherein the metal layer comprises atoms of at least one of aluminum, copper, gold, titanium, indium, tungsten, chromium, nickel, tantalum, molybdenum, palladium, or platinum.

4. The method of claim 1, wherein the substance comprises an organic substance.

5. The method of claim 4, wherein the substance comprises a photoresist.

6. The method of claim 1, wherein the substrate comprises an inorganic substrate.

7. The method of claim 6, wherein the substrate comprises a semiconductor substrate.

8. The method of claim 1, wherein the fluid spray comprises a liquid spray.

9. The method of claim 8, wherein the liquid spray comprises water.

10. The method of claim 9, wherein the liquid spray comprises >95% water.

11. The method of claim 1, wherein the fluid spray comprises a gas spray.

12. The method of claim 11, wherein the gas spray comprises an inert gas.

13. The method of claim 1, wherein the incidence angle comprises an angle greater than 45 degrees.

14. The method of claim 13, wherein the incidence angle comprises an angle greater than 85 degrees.

15. The method of claim 14, wherein the incidence angle comprises an angle of about 90 degrees.

16. The method of claim 1, wherein the pressure comprises between about 25 and 200 pounds square inch gauge (psig) of pressure.

17. The method of claim 16, wherein the pressure comprises between about 35 and 55 psig of pressure.

18. The method of claim 1, wherein applying the spray comprises applying the spray with a nozzle.

19. The method of claim 18, wherein the nozzle comprises a fan nozzle having a nozzle spray angle between about 5 and 45 degrees.

20. The method of claim 19, wherein the nozzle spray angle is between about 10 and 20 degrees.

21. The method of claim 20, wherein the nozzle spray angle is about 15 degrees.

22. The method of claim 18, wherein a separation distance between the nozzle and the substance is between about 1 and 10 centimeters.

23. The method of claim 22, wherein the separation distance is about 4 centimeters.

24. The method of claim 1, further comprising drying the substance and the substrate prior to removing the substance from the substrate.

25. The method of claim 1, further comprising:
applying a liquid to a surface of the metal layer for a period of time and at a temperature sufficient for chemical interaction between the liquid and the substance to cause at least a portion of the metal layer to separate from the substance.

26. The method of claim 25, wherein the liquid is applied to at least a portion of the surface of the metal layer and applying the spray comprises applying the spray to the portion of the surface of the metal layer to which the liquid was applied.

27. The method of claim 26, wherein a volume of the liquid applied to the surface of the metal layer is less than about 100 microliters.

28. The method of claim 27, wherein a volume of the liquid applied to the surface of the metal layer is less than or equal to about 50 microliters.

29. The method of claim 27, wherein a volume of the liquid applied to the surface of the metal layer is one drop.

30. The method of claim 25, wherein the liquid is applied to substantially the entire surface of the metal layer.

31. The method of claim 25, wherein the liquid comprises a basic aqueous solution, an acid aqueous solution, a water-soluble organic solvent, or a non-polar solvent.

32. The method of claim 31, wherein the liquid comprises the basic aqueous solution and the basic aqueous solution comprises a base selected from the group comprising potassium hydroxide, sodium hydroxide, lithium hydroxide, ammonium hydroxide, tetramethylammonium hydroxide, tetraethylammonium hydroxide, tetrabutylammonium hydroxide, and mixtures thereof.

33. The method of claim 31, wherein the liquid comprises the water-soluble organic solvent and the water-soluble organic solvent is selected from the group comprising dimethyl sulfoxide (DMSO), n-methyl pyrrolidone (NMP), diethylene glycol monobutyl ether (DB solvent), diethylene glycol monoethyl ether (DE solvent), isopropanol, acetone, monoethanolamine (MEA), dimethylformamide, and mixtures thereof.

34. The method of claim 25, wherein the period of time is between about 5 and 300 seconds.

35. The method of claim 34, wherein the period of time is between about 15 and 60 seconds.

36. A method for removing a metal layer that contacts a substance, said substance disposed on a substrate, the method comprising:
applying a liquid to a surface of the metal layer for a period of time and at a temperature sufficient to enhance removal of at least a portion of the metal layer from the substance by spraying with a fluid spray;
spraying the metal layer, at a location of contact with the liquid, with a fluid spray at a pressure and an incidence angle sufficient to remove at least a portion of the metal layer from the substance without significantly removing the substance from the substrate;
drying the substance and the substrate; and
removing the substance from the substrate, wherein the removing occurs in a same bowl as the applying, spraying, and drying.

37. The method of claim 36, wherein applying the liquid comprises applying the liquid to a discrete location on the surface of the metal layer.

38. The method of claim 36, wherein applying the liquid comprises applying the liquid to the entire surface of the metal layer.

39. The method of claim 36, wherein a portion of the metal layer remains on the substance after the spraying and the removing comprises removing the portion of the metal layer with the substance.

40. The method of claim 36, wherein the liquid comprises a basic aqueous solution or a water-soluble organic solvent.

41. The method of claim 36, wherein the period of time comprises between about 5 and 120 seconds and the temperature comprises room temperature.

42. The method of claim 36, wherein the spraying comprising using a fan nozzle with a nozzle spray angle between about 5 and 45 degrees at a distance of about 2 to 6 centimeters from the substance with a pressure of about 35 to 55 psig at an incidence angle greater than 85 degrees.

43. The method of claim 36, wherein the spraying comprises spraying while the substance is rotating at a rate of less than 500 revolutions per minute (rpm).

44. The method of claim 43, wherein the rate is less than 250 rpm.

45. The method of claim 43, wherein the spraying comprises moving the spray from a starting position across the surface of the substance while the substance and the substrate are rotating.

46. The method of claim 45, wherein the rate is less than 100 rpm.
